(19) United States
(12) Patent Application Publication
(10) Pub. No.: US 2002/0193714 A1
(43) Pub. Date: Dec. 19, 2002

(54) Article and method for self-administered physical therapy to alleviate back pain

(76) Inventor: Ralph R. Pecora, Baltimore, MD (US)

Correspondence Address: ROYAL W. CRAIG, A PROFESSIONAL CORPORATION, SUITE 153, 10 NORTH CALVERT STREET, BALTIMORE, MD, 21202, US

(21) Appl. No.: 10/171,400

(22) Filed: Jun. 13, 2002

Related U.S. Application Data
(60) Provisional application No. 60/297,803, filed on Jun. 13, 2001.

(51) Int. Cl. A61H 15/00

(52) U.S. Cl. 601/121

(57) ABSTRACT

A therapeutic device for alleviating mid-to-upper back pain. The device comprises a hard cylindrical body wrapped in a cushioning sleeve. The sleeve is sufficiently firm to resist deforming, thereby maintaining its round shape and enabling it to roll easily along the ground. At the same time, the sleeve comfortably supports the user and transfers the force of the hard inner element to the user's back muscles and joints without causing pain or injury. The device can be used by individuals suffering from mid-to-upper back pain associated with muscle spasms, soreness, or injury. The device enables the individual to self-administer therapy to the back muscles and joints to relieve back pain and reduce the likelihood of future incidences of pain.

### CROSS-REFERENCE TO RELATED APPLICATIONS

The present application derives priority from U.S. Provisional Patent Application 60/297,803, filed: Jun. 13, 2001.

### BACKGROUND OF THE INVENTION

1. Field of the Invention

The present invention relates to physical therapy devices, and, more particularly, to a therapeutic device for alleviating mid-to-upper back pain resulting from muscle spasms or tired, stiff muscles.

2. Description of the Background

Worldwide back pain is estimated to afflict 60-80% of the human population at some point in their lives, and it afflicts 2-5% of the population at any given time. Anatomically, the back is divisible into three regions defined by the vertebrae of the spinal column. Beginning at the neck, the first 7 descending vertebrae are the cervical vertebrae. Next, the thoracic region consists of 12 vertebrae, and finally the lumbar region comprises five vertebrae of the lower back. The trapezius and the latissimus dorsi represent two large muscle groups in the back most commonly associated with muscular back pain. The present invention is directed to alleviating the discomfort and debilitating effects of mid-to-upper back pain, generally corresponding to regions of the thoracic and cervical vertebrae.

Causes of mid-to-upper back pain vary widely. Poor posture weakens muscles and strains joints and ligaments causing upper back pain. Straining or over-exercising the upper back can also cause pain. Large breasts can place stress on the upper back causing pain in muscles and joints. Diseases such as osteoporosis, and injuries from automobile accidents or participation in athletics additionally contribute to upper back pain.

Uncomplicated back pain afflicts the majority of back pain sufferers, while chronic back pain accounts for the remainder. Most people suffering from uncomplicated back pain recover spontaneously, without medical intervention. However, scientific studies show that activity improves the rate of recovery and reduces the incidences of future episodes of upper back pain. Patients who exercise get better faster and, if they keep exercising, are less likely to have future episodes.

Current recommended treatments for upper back pain in uncomplicated cases include rest, avoiding use of the upper back muscles, implementing a progressive exercise program of isometric strengthening, range-of-motion exercises, stretching, and aerobic conditioning. Heat, ultrasound, massage, and electrical stimulation are also currently recognized as treatments for alleviating mid-to-upper back pain.

An effective treatment for relieving back pain is to gently knead the muscles. Kneading relieves pain by stretching the area and increasing circulation. Pressing on the area slows the blood supply briefly, and releasing it floods the area with blood and oxygen, often allowing a muscle in spasm to relax. Spinal manipulation to selected joints of the spine also effectively reduces pain. Pressure applied to the joints and ligaments decreases the amount of pain and shortens the episode of discomfort.

Unfortunately, massage therapy and spinal manipulation therapy are expensive treatments because they require an experienced and licensed practitioner to perform the procedures. Such therapy is inconvenient and time consuming as it requires scheduling and attending appointments with a therapist. Moreover, an individual who suffers from episodes of back pain often needs instant relief and is often unable to wait for a scheduled appointment. Accordingly, it would be useful to provide an apparatus for gently kneading and massaging the back of an individual experiencing mid-to-upper back pain to promote circulation, apply pressure to the joints, and stretch the muscles. It would likewise be beneficial to provide a method whereby the individual could use the device to self-administer therapy during an episode of muscle spasm or back pain.

### SUMMARY OF THE INVENTION

It is, therefore, an object of the present invention to provide a simple and effective device for manipulation and massage of the muscles and joints of the mid-to-upper back.

It is another object of the present invention to provide a method to self-administer a massage to the muscles and joints of the mid-to-upper back to relieve back pain using the device of the present invention.

According to the present invention, the above-described and other objects are accomplished by providing a hard cylindrical tube encased in a firm outer cushion. The device enables an individual to self-administer a massage to the mid-to-upper back to relieve back pain. The user rests the device on the ground and reclines his body onto the device. The user raises his buttocks, and pushing-off with the feet, causes the device to roll forward and backward along the back from the shoulders to approximately the ninth thoracic vertebra (nearly to the bottom of the rib cage). The weight of the user's body bearing downwardly on the device creates upward pressure from the device increasing blood flow and kneading the joints in the back to relieve pain.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a top perspective view of the device of the present invention.

FIG. 2 is an exploded view of the device of the present invention.

FIG. 3 is a side schematic view illustrating the device of the present invention in use.

### DETAILED DESCRIPTION OF THE PREFERRED EMBODIMENTS

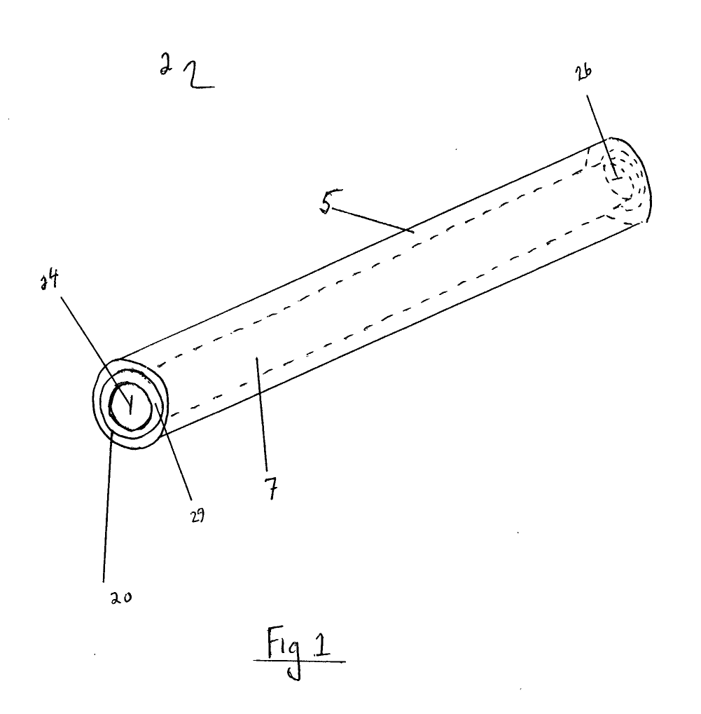

A therapeutic device according to the present invention is shown generally by reference numeral 2 in the drawings. FIG. 1 shows a perspective view of the device in a fully assembled operative configuration. The device 2 is generally a long cylindrical body having opposing first and second ends. The body comprises a firm outer sleeve 5 encasing a hard cylindrical tube 7. The assembled device is preferably 23″ long with a 4″ outside diameter.

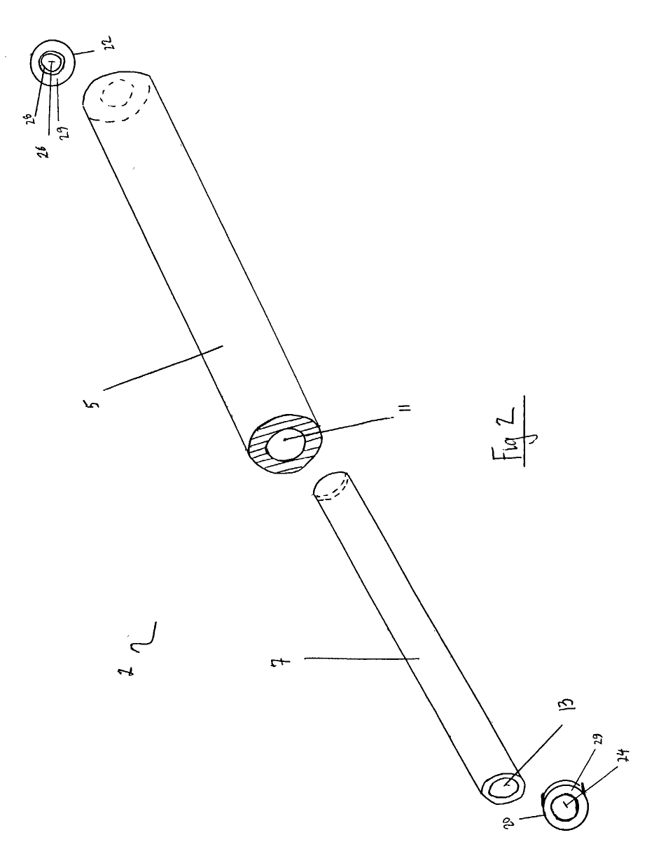

Tube 7 is preferably of polyvinyl chloride (PVC) or similarly hard material and preferably comprises a hollow cylindrical body. Opposing first end and second end of tube 7 are connected by an interior channel 13 (visible in FIG. 2). Tube 7 extends the length of the interior of device 2, and preferably has an outside diameter of 2½″.

Sleeve 5 is a cylindrically shaped tube having opposing open first and second ends connected via a hollow central channel 11 (shown in FIG. 2). Sleeve 5 encases tube 7, and forms a seamless jacket having the same cylindrical shape and length dimensions of tube 7. The inside diameter of channel 11 is nearly the same as the outside diameter of tube 7, thereby enabling the sleeve to slide snugly over tube 7.

Sleeve 5 is preferably a firm yet supple material for transmitting force from tube 7 to the user's back while at the same time providing cushioned support to the user. Sleeve 5 maintains a uniformly round shape during use, allowing it to roll smoothly and evenly over the ground. While sleeve 5 is sufficiently firm to resist deforming under the weight of the user, it is soft enough to cushion the user from the discomfort that would result from rolling tube 7 directly against the user's back. Armstrong AP/Armaflex T 25/50 pipe insulation material is an exemplary sleeve material which exhibits the proper firmness and cushioning qualities appropriate to the therapeutic device 2.

FIG. 2 is an exploded view of the therapeutic device 2 of the present invention which illustrates its assembly. Circular end caps 20, 22 cover the opposing ends and conceal the hollow interior channel 13. End caps 20, 22 are preferably a hard molded plastic material having a flat circular outwardly disposed face 24 and an inwardly disposed face 26. The inwardly disposed face 26 is formed with a circular groove 28 which engages the end of tube 7 along its perimeter and secures the end caps to the device 2. Outwardly disposed face 24 comprises a lip 29 about its circumference. Lip 29 forms a ring structure which overlaps the end panels of sleeve 5. Lip 29 thereby helps to retain tube 7 inside of sleeve 5.

Still referring to FIG. 2, tube 7 is shown removed from sleeve 5, revealing the hollow inner channel 11 of sleeve 5. End cap 22 is shown removed from an end of the device 2. Groove 28 is visible on the inside face of end cap 22. Tube 7 comprises a hollow interior channel 13 as shown in FIG. 2. The outwardly disposed face of lip 29 is visible on end cap 20 which is shown removed from the device 2. The inwardly disposed face of lip 29 is visible on end cap 22.

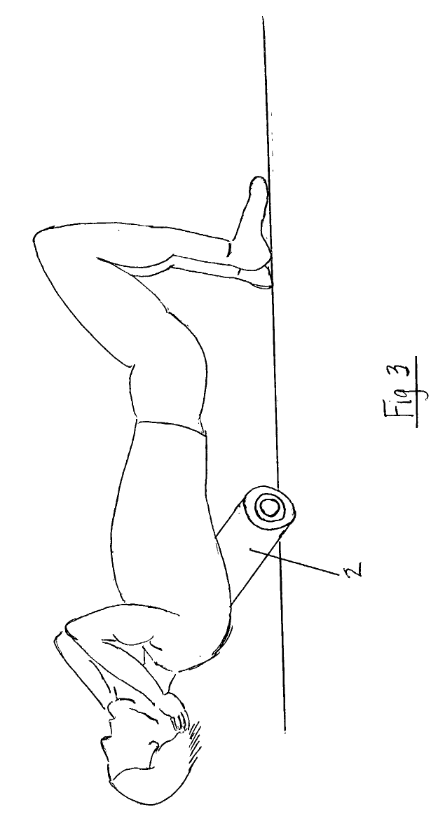

As shown in the schematic view of FIG. 3, in use, the therapeutic device 2 is placed horizontally on the ground. The user lies in a supine position on top of the device, placed across the shoulder blades. To mount the device, the user lies on his side next to the device and rolls over onto it. The user places his hands together behind the neck to support the head. Next, the user bends at the knees with the feet planted firmly on the floor, raising the buttocks off the ground and causing his body weight to bear down on the device. The device thereby becomes a fulcrum supporting the weight of the user's body. Pushing off with the feet causes the therapeutic device 2 to roll from the shoulder blades to approximately the ninth thoracic vertebra (nearly to the bottom of the rib cage) and back again to the shoulders. The rolling movement kneads the muscles and promotes circulation to relax muscle spasms. The device also manipulates joints and ligaments as it rolls back and forth, bringing relief via application of pressure. The movement is repeated in multiple sets of 2-4 repetitions for best results.

Varying the position of the elbows from horizontal to vertical (relative to the floor) alters the area of the back worked by the device. Lowered elbows accentuates the lateral portions of the back, while raised elbows cause the device to work the central portion of the back. By positioning the elbows between the lowered and raised extremes, the user can direct the therapy to intermediate areas experiencing muscle spasm or pain.

Having now fully set forth the preferred embodiments and certain modifications of the concept underlying the present invention, various other embodiments as well as certain variations and of the embodiments herein shown and described will obviously occur to those skilled in the art upon becoming familiar with said underlying concept. It is to be understood, therefore, that the invention may be practiced otherwise than as specifically set forth in the appended claims:

I claim:

1. A therapeutic device for alleviating back pain, comprising:
(a) a hard cylindrical tube having opposing first and second ends; and
(b) a sleeve-like cushion having a cylindrical shape and opposing open first and second ends connected by a hollow central channel
whereby said central channel slidingly engages said cylindrical tube and remains open at said first end and second end.

2. The therapeutic device as recited in claim 1, wherein a pair of end caps covers said first end and said second end.

3. The therapeutic device as recited in claim 1, wherein said cylindrical body comprises a polyvinyl chloride pipe.

4. A method for relieving mid-to-upper back pain, comprising the steps of:
(a) placing the device of the present invention horizontally on the ground;
(b) lying in a supine position on the device, knees bent, feet planted firmly on the ground, buttocks raised off the ground causing the user's upper body weight to bear downwardly on the device;
(c) pushing off with the feet and rolling the device along the back from the shoulder blade to approximately the ninth thoracic vertebra and back again;
(d) repeating the movement in sets of 2-4 repetitions;
whereby said rolling movement kneads the back muscles and manipulates the back joints to relieve mid-to-upper back pain.
